(19) United States
(12) Patent Application Publication
(10) Pub. No.: US 2006/0042815 A1
(43) Pub. Date: Mar. 2, 2006

(54) Rod passage,especially for actuating rods in motor vehicles

(75) Inventors: Martin Wolff, Hattingen (DE); Johann-Georg Werner, Hamm (DE)

Correspondence Address: FOLEY & LARDNER LLP, 777 EAST WISCONSIN AVENUE, SUITE 3800, MILWAUKEE, WI, 53202-5308, US

(73) Assignee: Johnson Controls Interiors GmbH & Co. KG

(21) Appl. No.: 10/507,872

(22) PCT Filed: Mar. 13, 2003
(86) PCT No.: PCT/EP03/02612

§ 371 Date: Aug. 11, 2005

(30) Foreign Application Priority Data
Mar. 15, 2002 (DE) 102 11 629.6

(51) Int. Cl. H02G 3/06

(52) U.S. Cl. 174/65 R

(57) ABSTRACT

the invention relates to a passage for rods, especially for actuating rods (8) in a motor vehicle, comprising a receiving bushing (4) which is inserted into an assembly hole (2) of a component and which has an opening (6) for the rods (8). The receiving bushing (4) has, on one side, an extended auxiliary introduction element (16) protruding above the assembly hole (2) of the component in the form of a cone or a ramp whereby the end of the rods (8) to be introduced can be introduced into the opening of the passage (6) by slidingly placing it in or on the auxiliary introduction element (16).

### CROSS-REFERENCE TO RELATED PATENT APPLICATIONS

### BACKGROUND OF THE INVENTION

The present invention relates to a linkage passage, in particular for an activation linkage in a motor vehicle, having a receiving bushing which is to be inserted into a mounting opening in a component and which has a through-opening for the linkage.

It is frequently difficult to mount activation linkages, for example in the motor vehicle industry, because the corresponding mounting opening in the respective component is not directly visible or accessible from the side from which the linkage is to be inserted. For this reason, the mounting operation must be carried out by the fitter by touch, which is difficult and time-consuming and also includes the risk of incorrect mounting.

### SUMMARY OF THE INVENTION

The present invention is based on the object of simplifying the mounting of a linkage passage of the aforesaid type using simple and cost-effective means.

This is achieved according to the invention in that the receiving bushing has, at one end, an extended auxiliary insertion element which protrudes beyond the mounting opening of the component and is in the form of a ramp and/or funnel such that the linkage can be inserted, with an end which is to be inserted, into the through-opening by sliding abutment against or in the auxiliary insertion element. Here, the receiving bushing can be inserted into the mounting opening from an outside of the respective component with the auxiliary insertion element at the front, and if appropriate with elastic, radially tapering deformation of the auxiliary insertion element, in particular can be latched in said mounting opening in such a way that, in the inserted state, the auxiliary insertion element projects freely into an interior space of the component, while the receiving bushing finishes on the outside of the component so as to be preferably essentially flush with a component face which surrounds the mounting opening at the mouth end.

The invention significantly facilitates and simplifies the mounting of the linkage by virtue of the fact that, with the rod end which is to be inserted, the auxiliary insertion element according to the invention can be found more easily and more quickly owing to its significantly larger grasping region in comparison with the through-opening, and can then be inserted into the through-opening by abutting in a sliding-along fashion. For this purpose, a sliding insertion face of the auxiliary insertion element merges directly with the through-opening of the receiving bushing. The invention thus leads to a significant saving in time when mounting the linkage and to a significantly higher mounting reliability by avoiding incorrect mounting.

Further advantageous refinement features of the invention are contained in the subclaims and the following description.

### BRIEF DESCRIPTION OF THE DRAWINGS

The invention will be explained in more detail by means of preferred exemplary embodiments which are illustrated in the drawing, in which:

FIG. 1 shows a section through a component which is embodied with a linkage passage according to the invention.

FIG. 2 shows a perspective view of a first embodiment of a receiving bushing according to the invention, and

FIG. 3 shows a second embodiment of a receiving bushing according to the invention, again in a perspective view.

### DETAILED DESCRIPTION OF THE PREFERRED EMBODIMENTS

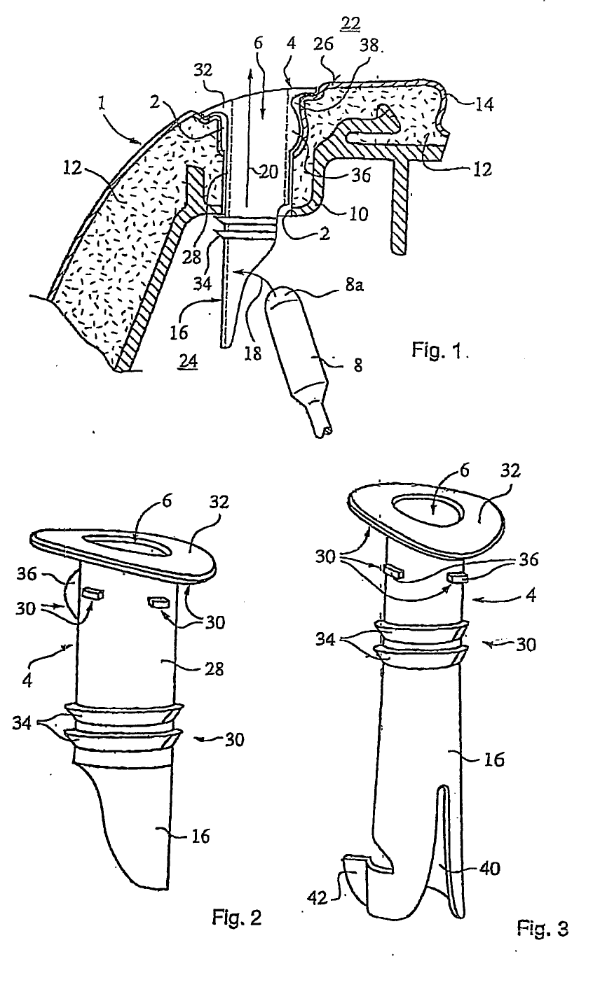

FIG. 1 illustrates part of a component 1 in section, which part may be, for example, the curb region of a vehicle door. The component 1 has a mounting opening 2 into which a receiving bushing 4 is inserted. The receiving bushing 4 has a through-opening 6 for a linkage 8 which is, in the application example illustrated, a locking rod for activating a door lock.

The component 1 can be embodied, as illustrated, as a multi-layer built-on part which is composed of a load-bearing, dimensionally stable structure 10, a foamed part 12 which is attached by foaming and an outer reference material 14.

According to the invention, the receiving bushing 4 has, at one end, an extended auxiliary insertion element 16 which protrudes beyond the mounting opening 2 in the component 1. This auxiliary insertion element 16 is embodied as a direct extension of the through-opening 6, in the manner of a ramp and/or funnel such that the linkage 8 is brought into abutment with an end 8a, to be inserted, in the direction of the arrow 18 according to FIG. 1, and can then be introduced by sliding abutment into the through-opening 6 in the direction of the arrow 20.

In the preferred embodiment, the receiving bushing 4 can be inserted, and specifically in particular latched, into the mounting opening 2 from an outside 22 of the component 1 with the auxiliary insertion element 16 at the front. In the inserted state (FIG. 1), the auxiliary insertion element 16 projects freely into an interior space 24 of the component 1, while the receiving bushing 4 preferably finishes on the outside 22 of the component so as to be essentially flush with a component face 26 which surrounds the mounting opening 2 at the mouth.

As is apparent from FIGS. 2 and 3, the receiving bushing 4 has a hollow cylindrical securing section 28 which has the through-opening 6, said securing section 28 having, for its part, fixing means 30 for securing the receiving bushing 4 in a positionally fixed fashion in the mounting opening 2 of the component 1. Thus, in order to secure the receiving bushing 4 in the insertion direction or the direction in which the linkage is led through, there is provision that, as fixing means 30, the securing section 28 has, on the one hand, a radial flange-like ring-shaped supporting extension 32—on its side lying opposite the auxiliary insertion element 16—for resting on the outer component surface 26 (or in a depression formed therein) and, on the other hand, at least one radial latching extension 34—in the region of the junction with the auxiliary insertion element 16—for engaging in a latching fashion behind an opening edge—pointing to the interior space 24 of the component—of the mounting opening 2. In the illustrated preferred embodiment, the securing section 28 has (at least) two latching extensions 34 which are offset with respect to one another in the insertion direction and in particular each run round in an annular shape and are formed with a barb-like or saw-tooth-like sectional contour. This configuration ensures a secure hold even when there are components 1 of different thicknesses or when the mounting opening 2 has different lengths, as is also the case, for example, with multi-layered built-on parts as illustrated in FIG. 1. As a result of the plurality of latching extensions 34 which are offset in the insertion direction, a play-free seat of the receiving bushing 4 in the mounting opening 2 is also brought about since one of the latching extensions 34 always ensures that the corresponding latching connection occurs even when there are materials of different thicknesses.

In order to secure the receiving bushing 4 against rotation, the fixing means 30 also have at least one positioning extension 36 which protrudes radially from the outer circumference of the securing section 28 and which engages in a corresponding position recess 38 within the mounting opening 2 of the respective component 1 (see FIG. 1). In the illustrated embodiments, in each case a plurality of position extensions 36 are provided in one particular suitable arrangement.

In order to make it even easier to find the auxiliary insertion element 16 when the linkage 8 is inserted, the auxiliary insertion element 16 is preferably formed in a groove-like fashion, and with a groove width which increases in the direction of its free end and exceeds the cross section of the mounting opening 2, said auxiliary insertion element 16 being embodied elastically here in such a way that the auxiliary insertion element 16 can be radially elastically compressed (can be made narrower) in the region it's the free end for insertion into the mounting opening 2. This can also be supported according to FIG. 3 by the auxiliary insertion element 16 having, at its free end, at least one longitudinal slit 40, which increases the elastic deformability.

Furthermore, in the configuration according to FIG. 3, there is provision that the auxiliary insertion element 16 has, in its free end region, additional latching means 42 for prefixing the linkage 8 in a latching fashion during mounting. These latching means 42 may be, as illustrated, a clip-shaped or tongue-shaped extension which engages around the fitted-on end 8a of the linkage 8 in a latching fashion.

The receiving bushing 4 according to the invention can be manufactured inexpensively and economically by virtue of the fact that it is embodied together with the auxiliary insertion element 16 as a single-piece plastic preform.

The invention is not restricted to the illustrated and described exemplary embodiments and applications but rather also comprises all embodiments which act identically in the sense of the invention. For example, the invention is basically suitable for all desired linkage passages, that is to say not only for a locking linkage in the curb region of a vehicle door. In addition, instead of a through-opening 6 with a circular cross section, the cross section may be any other desired opening cross section, for example oval or a rectangle with rounded corners, matched to the respective linkage, in which case the securing section 28 will also correspondingly differ from the hollow cylindrical shape.

1. A linkage passage, in particular for an activation linkage (8) in a motor vehicle, having a receiving bushing (4) which is to be inserted into a mounting opening (2) in a component (1) and which has a through-opening (6) for the linkage (8), characterized in that the receiving bushing (4) has, at one end, an extended auxiliary insertion element (16) which protrudes beyond the mounting opening (2) of the component (1) and is in the form of a ramp and/or funnel such that the linkage (8) can be inserted, with an end (8a) which is to be inserted, into the through-opening (6) by sliding abutment against or in the auxiliary insertion element (16).

2. The linkage passage as claimed in claim 1, characterized in that the receiving bushing (4) can be inserted into the mounting opening (2) from an outside (22) of the respective component (1) with the auxiliary insertion element (16) at the front, and if appropriate with elastic, radially tapering deformation of the auxiliary insertion element (16), in particular can be latched in said mounting opening (2) in such a way that, in the inserted state, the auxiliary insertion element (16) projects freely into an interior space (24) of the component (1), while the receiving bushing (4) finishes on the outside (22) of the component so as to be preferably essentially flush with the component face (26) which surrounds the mounting opening (2) at the mouth end.

3. The linkage passage as claimed in claim 1, characterized in that the receiving bushing (4) has a hollow cylindrical securing section (28) which has the through-opening (6), said securing section (28) having fixing means (30) for securing the receiving bushing (4) in a positionally fixed fashion in the mounting opening (2) of the component (1).

4. The linkage passage as claimed in claim 3, characterized in that, as fixing means (30), the securing section (28) of the receiving bushing (4) has, on the one hand, a radial flange-like supporting extension (32)—on its side lying opposite the auxiliary insertion element (16)—for resting on the outer component surface (26) and, on the other hand, at least one radial latching extension (34)—in the junction region with the auxiliary insertion element (16)—for engaging in a latching fashion behind an opening edge—pointing to the interior space (24) of the component—of the mounting opening (2).

5. The linkage passage as claimed in claim 4, characterized in that the securing section (28) has at least two latching extensions (34) which are offset with respect to one another in the insertion direction and in particular each run round in an annular shape and are formed with a barb-like sectional contour.

6. The linkage passage as claimed in claim 3, characterized in that the fixing means (30) have at least one position extension (36) which protrudes radially from the outer circumference of the securing section (28) and has the purpose of engaging a corresponding position recess (38) within the mounting opening (2) of the component (1).

7. The linkage passage as claimed in claim 1, characterized in that the auxiliary insertion element (16) is formed in a groove-like fashion, and in particular with a groove width which increases in the direction of its free end and exceeds the opening width of the mounting opening (2), said auxiliary insertion element (16) being embodied elastically herein such a way that the auxiliary insertion element (16) can be radially elastically compressed in the region of the free end for insertion into the mounting opening (22).

8. The linkage passage as claimed in claim 7, characterized in that the auxiliary insertion element (16) has at least one longitudinal slit (40) at its free end.

9. The linkage passage as claimed in claim 1, characterized in that the auxiliary insertion element (16) has, in its free end region, latching means (42) for prefixing the linkage (8) in a latching fashion during mounting.

10. The linkage passage as claimed in claim 1, characterized in that the receiving bushing (4) with the auxiliary insertion element (16) is formed as a single-piece plastic preform.

11. A linkage guide apparatus for use with an activation linkage (8) in a vehicle component (1) having a mounting opening (2) and an interior space, the linkage guide apparatus comprising:
a receiving bushing (4) configured for insertion into the mounting opening (2), with the bushing (4) defining a through-opening (6); and
an extended auxiliary insertion element (16) at one end of the receiving bushing (4) configured to slidingly guide the activation linkage (8) into the through-opening (6).

12. The linkage guide apparatus as claimed in claim 1, wherein the receiving bushing (4) can be inserted into the mounting opening (2) from an outside (22) of the respective component (1) with the auxiliary insertion element (16) at the front, and if appropriate with elastic, radially tapering deformation of the auxiliary insertion element (16), in particular can be latched in said mounting opening (2) in such a way that, in the inserted state, the auxiliary insertion element (16) projects freely into the interior space (24) of the component (1), while the receiving bushing (4) finishes on the outside (22) of the component so as to be preferably essentially flush with the component face (26) which surrounds the mounting opening (2).

13. The linkage guide apparatus as claimed in claim 11, wherein the receiving bushing (4) has a hollow cylindrical securing section (28) which has the through-opening (6), said securing section (28) having fixing means (30) for securing the receiving bushing (4) in a positionally fixed fashion in the mounting opening (2) of the component (1).

14. The linkage guide apparatus as claimed in claim 13, wherein fixing means (30), the securing section (28) of the receiving bushing (4) has, on the one hand, a radial flange-like supporting extension (32)—on its side lying opposite the auxiliary insertion element (16)—for resting on the outer component surface (26) and, on the other hand, at least one radial latching extension (34)—in the junction region with the auxiliary insertion element (16)—for engaging in a latching fashion behind an opening edge—pointing to the interior space (24) of the component—of the mounting opening (2).

15. The linkage guide apparatus as claimed in claim 14, wherein the securing section (28) has at least two latching extensions (34) which are offset with respect to one another in the insertion direction and in particular each run round in an annular shape and are formed with a barb-like sectional contour.

16. The linkage guide apparatus as claimed in one of claim 13, wherein the fixing means (30) have at least one position extension (36) which protrudes radially from the outer circumference of the securing section (28) and has the purpose of engaging a corresponding position recess (38) within the mounting opening (2) of the component (1).

17. The linkage guide apparatus as claimed in one of claim 11, wherein the auxiliary insertion element (16) is formed in a groove-like fashion, and in particular with a groove width which increases in the direction of its free end and exceeds the opening width of the mounting opening (2), said auxiliary insertion element (16) being embodied elastically herein such a way that the auxiliary insertion element (16) can be radially elastically compressed in the region of the free end for insertion into the mounting opening (2).

18. The linkage guide apparatus as claimed in claim 17, wherein the auxiliary insertion element (16) has at least one longitudinal slit (40) at its free end.

19. The linkage guide apparatus as claimed in one of claim 11 wherein the auxiliary insertion element (16) has, in its free end region, latching means (42) for prefixing the linkage (8) in a latching fashion during mounting.

20. The linkage guide apparatus as claimed in one of claim 11, wherein the receiving bushing (4) with the auxiliary insertion element (16) is formed as a single-piece plastic preform.

21. A method for guiding an activation linkage with a linkage guide apparatus, wherein the activation linkage is coupled to a vehicle component having a mounting opening and an interior space, the method comprising the steps of:
providing a receiving bushing configured for insertion into the mounting opening and defining a through-opening;
providing an extended auxiliary insertion element on one end of the receiving bushing;
configuring the insertion element to slidingly guide the activation linkage into the through-opening;
inserting the receiving bushing into the mounting opening; and
inserting the activation linkage into the auxiliary insertion element of the receiving bushing and sliding the activation linkage into a pre-selected position.

22. The method of claim 21, including the step of providing a securing section on the receiving bushing, with the securing section configured to secure the receiving bushing in the mounting opening.

23. The method of claim 21, including the step of combining the receiving bushing and extended auxiliary insertion element into a single piece.
